(19) United States
(12) Patent Application Publication
(10) Pub. No.: US 2020/0118193 A1
(43) Pub. Date: Apr. 16, 2020

(54) DIGITAL CONTENT PUBLISHER NEGOTIATED TRANSACTIONAL ADVERTISER

(71) Applicant: INTERNATIONAL BUSINESS MACHINES CORPORATION, Armonk, NY (US)

(72) Inventors: Mohan Minoru Narayanswamy, BLANCHARDSTOWN (IR); LEHO NIGUL, Richmond Hill (CA); Uttam Setty, Bangalore (IN)

(21) Appl. No.: 16/159,028

(22) Filed: Oct. 12, 2018

(51) Int. Cl. G06Q 30/06; G06Q 10/08

(52) U.S. Cl. CPC G06Q 30/0633; G06Q 30/0631; G06Q 10/087

(57) ABSTRACT

Aspects of the present invention provide devices that receive a request for digital content, the digital content request includes a list of vendor-object pairs, each object in the vendor-object pairs is identified in requested digital content, and each object in the vendor-object pairs includes a request for vending of the object from a corresponding vendor in the vendor-object pairs. The devices determine acceptance of the digital content request to offer vending of one or more objects in the vendor-object pairs, and send a vendor response, which offers the vending of the one or more objects in the vendor-object pairs.

### BACKGROUND

The field of e-commerce includes publishing of digital content and online advertising.

Digital content is any content that exists in the form of digital data. Also known as digital media, digital content is stored on digital or analog storage in specific formats. Forms of digital content include information that is digitally broadcast, streamed, or contained in computer files. Examples of digital data can include electronic text, image, video, audio and combinations thereof. Published digital content is typically provided to consumers through content providers or publishers using mobile computing applications, web browsers, and computer servers. The publishers can include entities, such as for example, news reporting organizations, weather reporting organizations, navigation system providers, music providers, eBook providers, blog providers, social media providers, and the like.

A conventional approach to online advertising of products and/or services by vendors is to place ads with a selection of digital publishers, which provide a predetermined volume of requests or provide a user population with similar historical demographics to consumers of the vendor products and/or services. The displayed ads include push techniques, such as banners displayed above, below, or alongside the published content; ad regions displayed within the published content; and ads displayed preceding the display of the published content, such as in pop-up windows, etc. The ads push displays of products predetermined before delivery of content is requested from the publisher. Advertising to the target populations is based on a likelihood that receivers of the published digital content, when they see the displayed ads, will respond and purchase products of the vendor, such as by clicking on the displayed ad. Some publishers offer consumers a choice to accept the digital content with the ads where the publisher receives a fee from the vendors, or a choice to subscribe for a fee to the digital content for ad free digital content.

### BRIEF SUMMARY

In one aspect of the present invention, a computer-implemented method transactional-enabled publication of digital content includes executing on a computer processor receiving a request for digital content, wherein the digital content request includes a list of vendor-object pairs. Each object in the vendor-object pairs is identified in requested digital content. Each object in the vendor-object pairs includes a request for vending of the object from a corresponding vendor in the vendor-object pairs. The computer processor determines acceptance of the digital content request to offer vending of one or more objects in the vendor-object pairs, and sends a vendor response, which offers the vending of the one or more objects in the vendor-object pairs.

In another aspect, a system has a hardware processor, computer readable memory in circuit communication with the processor, and a computer-readable storage medium in circuit communication with the processor and having program instructions stored thereon. The processor executes the program instructions stored on the computer-readable storage medium via the computer readable memory and thereby receives a request for digital content, wherein the digital content request includes a list of vendor-object pairs. Each object in the vendor-object pairs is identified in the requested digital content. Each object in the vendor-object pairs includes a request for vending of the object from a corresponding vendor in the vendor-object pairs. The processor determines acceptance of the digital content request to offer vending of one or more objects in the vendor-object pairs, and sends a vendor response, which offers the vending of the one or more objects in the vendor-object pairs.

In another aspect, a computer program product for transactional-enabled publication of digital content has a computer-readable storage medium with computer readable program code embodied therewith. The computer readable hardware medium is not a transitory signal per se. The computer readable program code includes instructions for execution by a processor that cause the processor to receive a request for digital content, wherein the digital content request includes a list of vendor-object pairs. Each object in the vendor-object pairs is identified in the requested digital content. Each object in the vendor-object pairs includes a request for vending of the object from a corresponding vendor in the vendor-object pairs. The processor determines acceptance of the digital content request to offer vending of one or more objects in the vendor-object pairs, and sends a vendor response, which offers the vending of the one or more objects in the vendor-object pairs.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts abstraction model layers according to an embodiment of the present invention.

FIG. 3 depicts a computerized aspect according to an embodiment of the present invention.

FIG. 4 is a flow chart illustration of an embodiment of the present invention.

FIG. 5 is a flow chart illustration of another embodiment of the present invention.

FIG. 6 depicts a schematic illustration of another embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

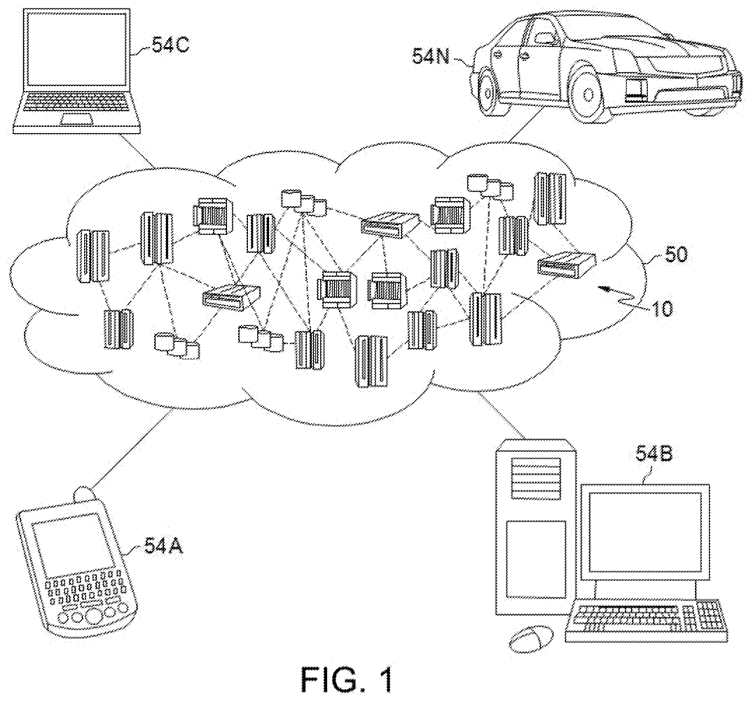

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

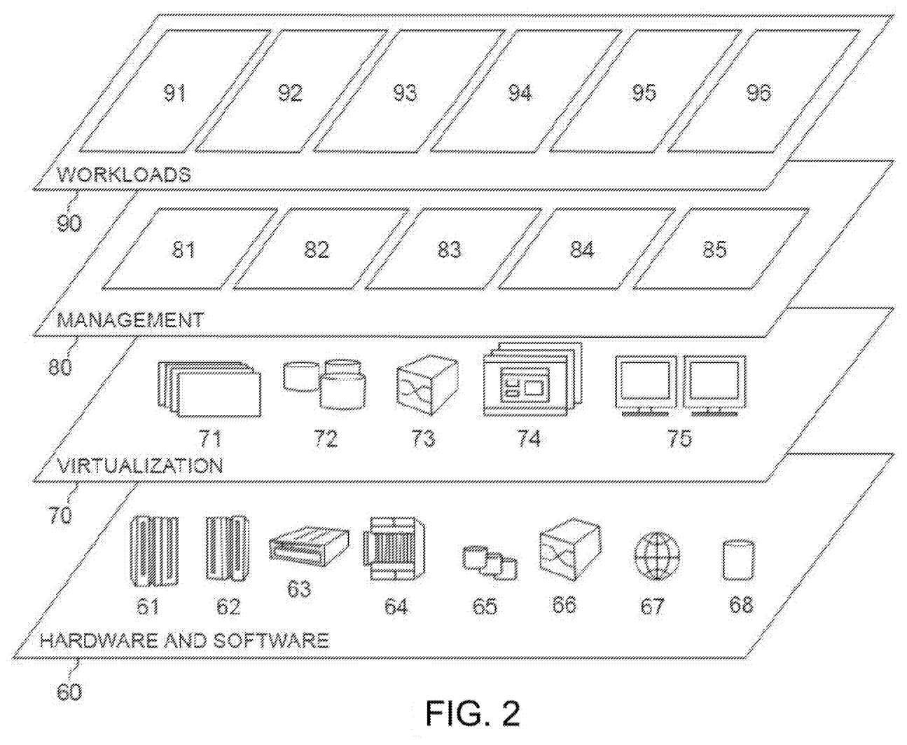

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing for the transactional-enabled publication of digital content 96 according to embodiments of the present invention.

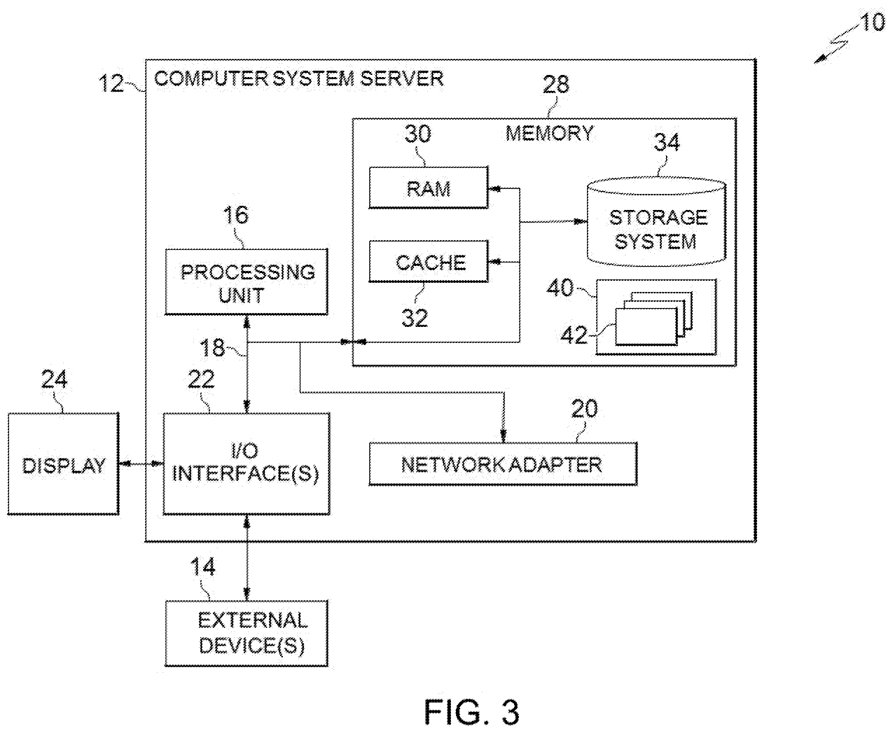

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

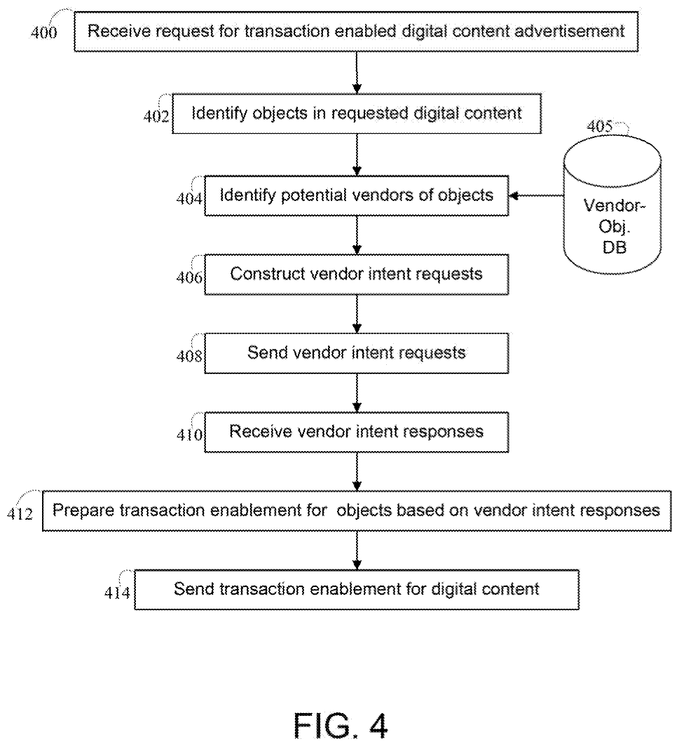

FIG. 4 illustrates one embodiment of a method according to the present invention for transactional-enabled publication of digital content. At 400, a processor that is configured according to an aspect of the present invention (the “configured processor”) receives a request for transaction enabled advertisement of digital content. The received request for transaction enabled advertisement of digital content includes digital content or a link to the digital content, which is retrieved according to the link. The received request for transaction enabled advertisement of digital content includes a name of a deliverer delivering the digital content to a user, such as a name of a website, a portal, a server servicing a mobile application, a server of a digital content publisher, and the like. The received request for transaction enabled advertisement of digital content can include user specific demographics according to the user that requested the digital content. The user specific demographics can include characteristics of the user, such as, for example, age, income, etc. The user specific demographics can include location information, such as the geographic location of user, such as, for example, global positioning satellite (GPS) location, country, state, city, zip code, and the like. The configured processor may be implemented in accordance with the computer system server 12 of FIG. 3, including as the cloud node 10 of FIG. 1, as described respectively above.

At 402, the configured processor identifies objects in the digital content. For example, the configured processor can identify objects in images or video, such as, for example, through object recognition or computer vision techniques. The configured processor can identify objects in text, such as, for example, using named entity recognition techniques. The configured processor can identify objects in audio, such as, for example, converting speech to text or obtaining subtitles, and using named entity recognition techniques on the text. The identified objects in the digital content include a list of objects. For example, in an article than includes an image of a tennis player and mentions in accompanying text sun glasses, the configured processor identifies a list that includes a hat, a t-shirt, shorts, tennis racket, tennis shoes and sun glasses. The list of objects includes a description of each object.

At 404, the configured processor identifies potential vendors of the identified objects. The identification includes a list of vendor-object pairs obtained from a vendor-object database 405. The vendor-object database 405 is suitably embodied by the computer readable electronic storage medium accessible by the database software 68. The vendor-object database 405 includes access by object or object classes to potential vendors. For example, access can include an object of “tennis shoes,” an object class of “athletic footwear,” a further object class of “footwear” and combinations thereof. In some embodiments, vendors interested in enabling transaction capability to digital content of the publisher populate the vendor-object database 405. In some embodiments, third parties or brokers populate the vendor-object database 405. In some embodiments, the digital content publisher populates the vendor-object database 405 according to agreements with vendors. Combinations of the above are contemplated.

In some embodiments, each vendor-object pair is assigned a relative weight based on the user specific demographics, information gathered from external sources, such as social media, internal or publisher preferences, and combinations thereof. In some embodiments, the configured processor selects those vendor-object pairs above a predetermined threshold value of the relative weight.

At 406, the configured processor constructs requests for digital content. In the present example the requests for digital content are referred to as a “vendor intent” requests. Each vendor intent request requests vending for at least one object for a respective vendor included in the vendor-object pairs, and an affirmative response to the vendor intent request includes an offer to vend the object by the transaction enabled advertisement. Each vendor intent request includes a name or identifier of digital content deliverer obtained from the received request for transaction enabled advertisement. Each vendor intent request includes a list of the identified vendor-object pairs for which vending is requested. One vendor can include a plurality of objects and one object can include a plurality of vendors. That is, one vendor can occur in multiple vendor-object pairs, and one object can occur in multiple vendor-object pairs. For example, continuing the example from above, the vendor requests include pairs of vendor-objects for vendor A with the tennis racket, vendor B with the tennis racket, vendor A with the tennis shoes and vendor C with the sun glasses. Each vendor intent request can include other identified objects of interest from the digital content. For example, the t-shirt and the shorts from the above example, where no vendor is included. Each vendor intent request can include the user specific demographics. Each vendor intent request can include the digital content or a link to the digital content.

In some embodiments, the vendor intent request includes an identifier of a particular vendor intent request, which distinguishes the vendor intent request from other vendor intent requests. For example, the vendor intent request sent to vendor A includes a different identifier than the vendor intent request sent to vendor B for a same request for transaction enabled advertisement. In some embodiments, the vendor intent request includes a transaction identifier, which identifies the request for transaction enabled advertisement that is common to the vendor intent requests for a same request for transaction enabled advertisement.

At 408, the configured processor sends the vendor intent requests over the network, described previously, to a computer server of each vendor or entity representative in the list of vendor-object pairs. The computer server of each vendor or entity representative can include another node 10, suitably embodied by another computer server, such as depicted in FIG. 3. In some embodiments, the computer server of each vendor or entity representative includes an application programming interface (API).

At 410, the configured processor receives vendor responses to the sent vendor intent requests. The vendor responses include rules, which indicate a vendor offer or refusal to vend one or more objects, and can include conditions to vend in the transaction enabled advertisement that is delivered with the published content.

The transaction enabled advertisement delivered with the published content enables a user selection of an object within the published content to provide a specified advertisement. For example, the user selects an object in a displayed image of the digital content, and a list of vendors vending the selected object is displayed with links to the specified advertisement of each corresponding vendor or the specified advertisement displayed in the instances of a single vendor. In some embodiments, the relative weight determines the order of display in the transaction enabled advertisement. For example, a user selects a shoe in the displayed digital content, and a list of vendors is presented and the list of vendors for the shoe is ordered by the relative weight.

The vendor response includes the specified advertisement, such as a link to a displayed ad, a link to a vendor website, linking program instructions, and the like. The specified advertisement can be specific to the selected object, specific to the identified potential vendors included in the vendor intent request, specific to the list or portions thereof of identified objects in the digital content, specific to the name of the digital content deliverer, the user specific demographics, and combinations thereof. In some embodiments, a vendor response is indicated as declined after elapse of a predetermined interval of time in which no vendor response is received.

The rules included in each of the vendor responses can include inclusion rules and exclusion rules for participation in the transaction enabled advertisement delivered with the published content. An inclusion rule is an offer to vend. For example, an example inclusion rule from vendor A includes “vendorA-object1,” or “vendorA-object1 all” which indicates vendor A offers to vend object 1. The inclusion rules can include conditional vendor-object pairs. For example, the vendor intent request includes vendor-object pairs of “vendorA-object1,” “vendorB-object1,” “vendorB-object2,” “vendorC-object1,” “vendorD-object2,” and “vendorE-object3.” An example inclusion rule received from the vendor response by vendor A indicates include “vendorA-object1 if vendorE-object3,” which indicates vendor A offers to vend object 1, if vendor E vends object 3. In some instances, the inclusion rule represents participation based on co-marketing.

An exclusion rule can indicate a refusal to vend by a vendor for a vendor-object pair. For example, “refuse vendorA-object1” indicates vendor A refuses or declines to vend object 1. An exclusion rule can include conditions. For example, “vendorA-object1 only if excludes vendorB-object1, vendorB-object2, vendorC-object1, and vendorD-object2,” which indicates vendor A offers to vend object 1 only if each of the other vendor-object pairs listed do not vend. In some instances, an exclusion rule allows vendors to restrict marketing to exclude other potential vendors with which the vendor will not co-vend.

At 412, the configured processor prepares transaction enabled advertisement of objects from vendor-object pairs based on the received vendor responses. The preparation includes resolving differences between rules received in each vendor response. For example, vendor A returns example rule “vendorA-object1 only if excludes vendorB-object1” and vendor B returns example rule “vendorB-object1 only if excludes vendor A-object1.” The weights, described above, can resolve differences between vendors. For example, if vendorA-object1 is weighted more than vendorB-object1 then vendorA-object1 is included in the transaction enablement and vendorB-object1 is excluded.

In some embodiments, delivered transaction enablement includes a set of vendor-object pairs, which include those offered for vending in the vendor responses with the inclusion/exclusion rules resolved by the configured processor. The resolution determines the vendor-object pairs in the set from the responses by applying the inclusion/exclusion rules and eliminating conflicts between vendor responses using the relative weights. The inclusion of the vendor-object pairs in the set changes the vendor-object pair from the offer to the vending. The delivered transaction enablement includes the corresponding specified advertisement for each object. In some embodiments, each vendor object pair of the set includes the relative weight. In some embodiments, the enablement includes a programming object based on the set of vendor-object pairs, such as, for example, hypertext mark-up language (HTML) code or javascript code to be included with the digital content returned to the user.

At 414, the transaction enablement is sent in response to the received request for transaction enabled digital advertisement. The transaction enablement can be sent to the sending node from which the request is received or another designated node. For example, the transaction enablement is returned to the webserver that sent the request, which returns the transaction enablement with digital content to the user.

In some instances, transaction enabled advertisement provides display space savings over conventional online advertising. The display space savings is available for digital content rather than advertising. In some instances, transaction enabled advertisement provides intelligently customized advertisement for selected items over conventional online advertising. Products are based on objects in the digital content rather than predetermined prior to the request for digital content and unrelated to the digital content. In some instances, transaction enabled advertisement provides intelligently customized advertisement for selected vendors over conventional online advertising. The selected vendors are in response to specific items in the digital content rather than a vendor selected to fill advertising space unrelated to a specific product interest by the user. In some instances, transaction enabled advertisement provides customer initiated pull advertisement over conventional push online advertising. The transaction enabled advertisement is only displayed in response to an input from the user indicating an object of interest, contrary to the conventional practice, which forces the advertisement display into the user's attention along with the digital content.

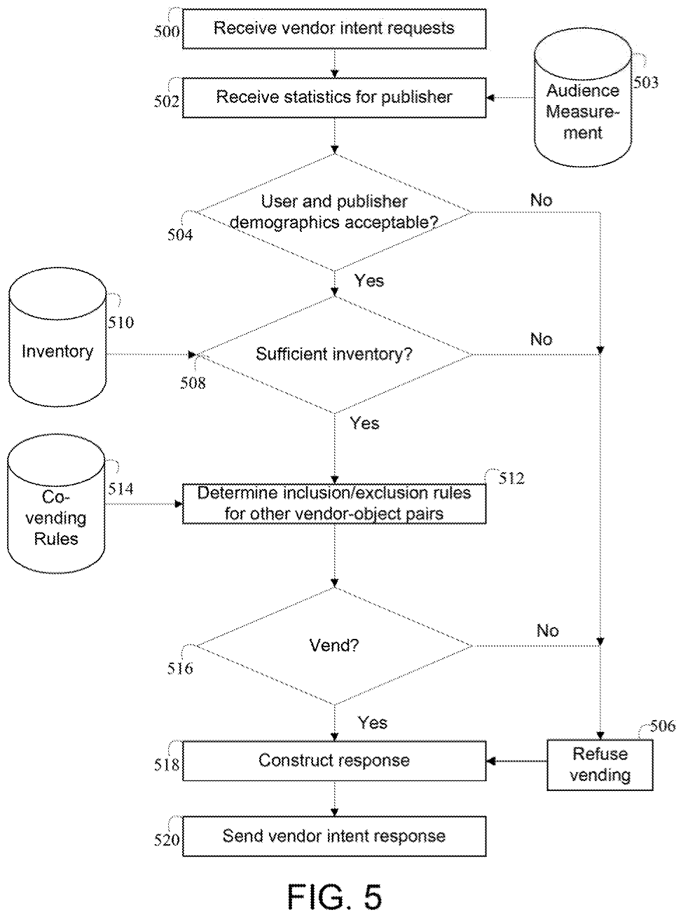

FIG. 5 illustrates one embodiment of a method according to the present invention for transactional enabled advertisement of requested digital content. At 500, the configured processor receives the vendor intent request. The vendor intent request includes the name or the identifier of digital content deliverer, the list of the identified vendor-object pairs for which vending is requested, the other identified objects of interest from the digital content, the user specific demographics, the identifier of a particular vendor intent request, the transaction identifier, the digital content or a link to the digital content, and combinations thereof. The vendor intent request can include each of the above items in the list, a link to one or more of the above items in the list, and combinations thereof. For example, the vendor intent request includes the name of the digital content deliverer and a link to the digital content. In some embodiments, the vendor intent request is sent as a link to the list of items in the vendor intent request. That is, the link is used to retrieve the above list.

At 502, the configured processor can obtain statistics from an audience measurement server 503 about the digital content deliverer, the digital content, and combinations thereof. The audience measurement server captures statistics of previously requested digital content from the digital content deliverer, the audience historically requesting digital content from the digital content deliverer, and combinations thereof. In some instances, the audience measurement server statistics can inform the vendor about the type of audience attracted by the digital content deliverer or a longitudinal perspective of the audience attracted by the digital content deliverer.

At 504, the configured processor can determine whether the obtained statistics from the audience measurement server 503 are acceptable. In some embodiments, the configured processor can determine whether the user specific demographics are acceptable. Combinations of the obtained statistics and the user specific demographics can be evaluated for an acceptable target audience or target user by a respective vendor receiving the vendor intent request.

If either of the obtained statistics or the user specific demographics are not acceptable, the configured processor, in response at 506, refuses the transaction enabled advertisement. In some embodiments, the refusal to vend all object-vendor pairs by the respective vendor includes no vendor intent response from the respective vendor. That is, no response is sent. In some embodiments, the refusal is implemented as an added exclusion rule that refuses to offer vending of objects in one or more of the vendor-object pair(s) by the respective vendor.

At 508, the configured processor can evaluate inventory of an object from an inventory database 510 in each vendor-object pair by the respective vendor for which vending is requested. For example, vendor A receives the list, which includes vendor-object pairs of “vendorA-object1” and “vendorA-object2” among other vendor-object pairs for other vendors. The configured processor checks the inventory in the inventory database 510 for object 1 and for object 2. For the objects with insufficient inventory, a rule refusing an offer to vend a corresponding object of one vendor-object pair can be added. In some embodiments, the refusal rule is a null rule that bars an offer for the vendor-object pair. In the instance that the evaluation of all objects includes insufficient inventory, the vendor request can be refused at 506.

In the instance that inventory is sufficient for some objects and insufficient for other objects, added rules include an offer to vend for objects with sufficient inventory, and added rules include a refusal to vend for objects with insufficient inventory. For example, object 1 has sufficient inventory and object 2 has insufficient inventory, an inclusion rule is added for object1 and a refusal rule is added for object2. An inclusion rule includes an offer to vend and can include conditions that if not satisfied include a refusal.

At 512, the configured processor determines inclusion/exclusion rules for the other vendor-object pairs according to co-vending rules 514 for each vendor-object pair for which vending is requested. For example, continuing the above example, with other vendor-object pairs of {“vendorB-object2,” “vendorC-object3,” “vendorD-object1”}, the rules are determined for each of “vendorA-object1” and “vendorA-object2” pairs by vendor A.

Inclusion rules can indicate an offer to vend conditional upon vending with at least one other vendor of the other vendor-object pairs. An example inclusive rule, “vendorA-object1 only if vendorC-object3” includes only co-vending with vendor C vending object 3 and a refusal of vending for object 1 otherwise. A different example inclusion rule, “vendorA-object2 only if vendorB-object2, vendorD-object1”, can be applied to the second vendor-object pair, which indicates an offer to co-vend with vendor B of object 2 and vendor D of object 1, and refusing to vend otherwise for object 2. Rules between vendor-object pairs are independent. For example, vendor A offer to vend object 1 is independent of vendor A offer to vend object 2 unless that vendor-object pair is included in the condition. For example, a rule “vendorA-object2 only if vendorA-object1,” indicates that vendor A offers to vend object 2 only if vendor A can also vend object 1.

In another example, where all of the other vendor-object pairs are acceptable for co-vending, then an example inclusion rule of “vendorA-object1” or “vendorA-object1 all”, such as from the inventory holds, where vendor A offers to vend object 1 independent of the responses from other vendors.

The inclusion rule or the exclusion rule can be an offer if conditions are satisfied and a refusal otherwise. Exclusion rules can indicate exclusion in an offer of at least one other vendor included in the vendor-object pairs. An example exclusion rule, “vendorA-object1 exclude vendorB-object2,” indicates vendor A offers to vend object 1 if vendor B is excluded from vending object 2, but otherwise refuses to vend. Another example exclusion rule, “vendorA-object1 exclude all” represents Vendor A exclusive offer to vend object 1 with no other vending by other vendors. In some embodiments, “all” can be represented by each of the other vendor-object pairs.

Thus, for each vendor-object for which vending is requested, such as, for example, “vendorA-object1” and “vendorA-object2”, an inclusion rule, an exclusion rule, and combinations thereof can be added for each object by a respective vendor.

Each of the other vendor-object pairs can participate in combinations of an inclusion rule and an exclusion rule for each respective object of the vendor-objects for which vending is requested from the respective vendor. A generalized form of the rule can be represented as {{refuse}, vendorX-objectN, {{include} all|vendorIᵢ-objectMⱼ, . . . },{{exclude} all|vendorJₒ-objectZₚ, . . . }}, wherein objectN is the object for which vending is offered from respective vendorX, vendorIᵢ-objectMᵢ represent each of the other vendor-object pairs conditioned on co-vending, and vendorJₒ-objectZₚ represents each of the other vendor-object pairs conditioned on exclusion.

The co-vending rules 514 can be accessible by object, object class, vendor, name of the digital content deliverer, and combinations thereof. In some embodiments, the co-vending rules 514 include the specified advertisement to be included for the object for the offer of vending. The specified advertisement can include a link to a website of the vendor, a specific online advertisement for the object, and the combinations thereof.

At 516, the configured processor can determine whether to vend for the published digital content based on combinations of the user specific demographics, the digital content, the digital content deliverer, the inventory of one or more objects, and the inclusion/exclusion rules of one or more objects. For example, based on user specific demographics and the inclusion of a combination of other vendor-object pairs, a vendor determines vending is not appropriate and should be refused. In another example, based on other objects of interest in the digital content, the rules should be modified to offer vending for all objects without conditions.

At 518, the configured processor constructs the vendor response. The vendor response includes the offer or refusal for each object of the list of vendor-object pairs from the respective vendor. The offer for each object from the respective vendor includes the specified advertisement for the transaction enabled advertisement. The offer for vending of each object from the respective vendor can include the inclusion/exclusion rules. The vendor response can include the vendor intent identifier and/or the transaction enabled advertisement identifier.

At 520, the configured processor sends the vendor response. For example, the vendor response is returned to the sender of the vendor intent request.

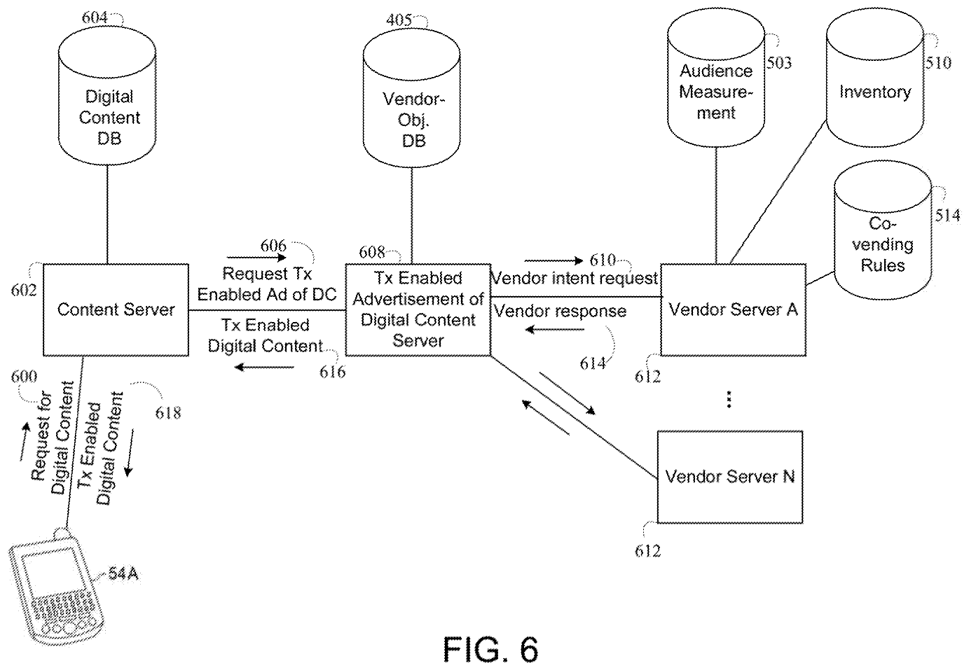

FIG. 6 schematically illustrates one embodiment of a system according to the present invention for transactional enabled advertisement of requested digital content. The local computing device 54A initiates the request for digital content 600, such as by selecting a digital content item indicated on a webpage. A content server 602, such as a webserver, receives the request for digital content 600 and retrieves the requested digital content from a digital content database 604. The content server formats the request for transaction enabled advertisement of digital content 606, which is communicated to a transaction enabled advertisement of digital content server 608. The request for transaction enabled advertisement of digital content 606 can be communicated using program to program communications, such as the API, peer-to-peer communications over the cloud 10, and the like. The request for transaction enabled advertisement of digital content 606 is machine readable electronic data, which can include links, data, and combinations thereof. In some embodiments, the request for transaction enabled advertisement of digital content 606 is machine readable electronic data and human readable electronic data, such as extensible hypertext markup language (XML) document. The machine readable electronic data can include a predefined format. In some embodiments, the machine readable electronic data can include meta data.

The transaction enabled advertisement of digital content server 608 processes the digital content and identifies objects in the processed digital content. The transaction enabled advertisement of digital content server 608 identifies potential vendors of the identified objects to obtain a list of vendor-object pairs from the vendor-object database 405, and constructs the vendor intent requests 610. The vendor intent requests 610 are sent to vendor servers 612 schematically represented as A . . . N where N is an integer greater than or equal to one. The vendor intent requests 610 is machine readable electronic data, which can include links, data, and combinations thereof.

Each vendor server 612 responds to the vendor intent request 610 by returning the vendor response 614 based on the statistics of the audience measurement, the evaluated inventory of the corresponding vendor, the co-vending rules 514 of the corresponding vendor, and combinations thereof. The vendor response 614 is machine readable electronic data, which can include links, data, and combinations thereof. The transaction enabled advertisement of digital content server 608 receives the vendor responses 614 from the various vendor servers 612.

The transaction enabled advertisement of digital content server 608 prepares transaction enabled advertisement of objects in the digital content 616 from the vendor-object pairs received in each vendor response. The transaction enabled advertisement of digital content server 608 delivers or returns the transaction enabled advertisement of objects in the digital content 616 to the content server 602.

The content server 602 adds the digital content to the transaction enabled advertisement of objects in the digital content 616 if not already present to form the transaction enabled advertisement of digital content 618, which is sent or returned to the local computing device 54A, such as in an webpage with accompanying program, which maps inputs from the local computing device 54A from a location in the digital content to an object with a vendor advertisement.

The transaction enabled advertisement of digital content provides an improvement to the ability of the computer to present information related to digital content that is more likely to be relevant to a user than conventional practices. For example, a user input selecting an object in digital content is more likely to be relevant to a user as indicated by the user input than displayed ads pushed along the requested digital content in conventional practice. That is, conventional practice co-displays the digital content and the advertisement determined at a time of delivery, while the transaction enabled advertisement of digital content defers advertisement until after delivery and after a user input indicative of interest in the object in the digital content. Furthermore, the focus of the enablement to objects within the digital content and negotiated between the vendor and publisher provides is more likely to satisfy the three parties involved in the transaction, which include the user, the digital content provider, and the vendor.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims, and as illustrated in the figures, may be distinguished, or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations, or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for transactional-enabled publication of digital content, comprising executing on a computer processor:
receiving a request for digital content, wherein the digital content request comprises a list of vendor-object pairs, wherein each object in the vendor-object pairs is identified in the requested digital content, wherein each object in the vendor-object pairs comprises a request for vending of the object from a corresponding vendor in the vendor-object pairs;
determining an acceptance of the digital content request to offer vending of one or more objects in the vendor-object pairs; and
sending a vendor response which offers the vending of the one or more objects in the vendor-object pairs.

2. The method of claim 1, further including:
constructing the vendor response to comprise a specified advertisement corresponding to one of the objects of the vendor-object pairs according to the determined acceptance, wherein a delivery of the requested digital content includes transactional enablement of the specified advertisement in response to an input which selects the one of the objects of the vendor-object pairs displayed in the requested digital content.

3. The method of claim 1, wherein determining acceptance of the digital content request comprises determining acceptance of vending for one of the objects of the vendor-object pairs conditional on inclusion of another vendor-object pair of a different vendor vending a second object, wherein determining acceptance of vending includes offering the one of the objects of the vendor-object pairs for vending conditional on the different vendor vending the second object;
wherein constructing the vendor response comprises adding a rule to the vendor response that identifies a condition of the vending of the one of the objects of the vendor-object pairs for vending only with the different vendor vending the second object.

4. The method of claim 1, wherein determining acceptance of the digital content request comprises determining acceptance of vending for one of the objects of the vendor-object pairs conditional on exclusion of another vendor-object pair of a different vendor vending a second object, wherein determining acceptance of vending includes offering the one of the objects of the vendor-object pairs for vending conditional on exclusion the different vendor vending of the second object;
wherein constructing the vendor response comprises adding a rule to the vendor response that identifies a condition of the vending of the one of the objects of the vendor-object pairs for vending only with excluding the different vendor vending of the second object.

5. The method of claim 1, wherein determining acceptance of the digital content request comprises evaluating inventory for one of the objects of the vendor-object pairs;
wherein constructing the vendor response comprises adding a rule to offer to vend the one of the objects of the vendor-object pairs according to the evaluated inventory.

6. The method of claim 1, wherein the digital content request further comprises a deliverer of the digital content; and
wherein determining acceptance of the digital content request comprises evaluating audience statistics for the deliverer of the digital content as a target audience for vending the one of the objects of the vendor-object pairs.

7. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the receiving the digital content request for transactional enabled advertisement of requested digital content, determining the acceptance of the digital content request, and sending the vendor response.

8. The method of claim 7, wherein the computer-readable program code is provided as a service in a cloud environment.

9. A system for transactional enabled advertisement of requested digital content, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
receives a request for digital content, wherein the digital content request comprises a list of vendor-object pairs, wherein each object in the vendor-object pairs is identified in the requested digital content, wherein each object in the vendor-object pairs comprises a request for vending of the object from a corresponding vendor in the vendor-object pairs;
determines an acceptance of the digital content request to offer vending of one or more objects in the vendor-object pairs; and
sends a vendor response which offers the vending of the one or more objects in the vendor-object pairs.

10. The system of claim 9, wherein the processor executes program instructions stored on the computer-readable storage medium via the computer readable memory and thereby:
constructs the vendor response to comprise a specified advertisement corresponding to one of the objects of the vendor-object pairs according to the determined acceptance, wherein a delivery of the requested digital content includes transactional enablement of the specified advertisement in response to an input which selects the one of the objects of the vendor-object pairs displayed in the requested digital content.

11. The system of claim 9, wherein the processor executes program instructions stored on the computer-readable storage medium via the computer readable memory and thereby:
determines acceptance of vending for one of the objects of the vendor-object pairs conditional on inclusion of another vendor-object pair of a different vendor vending a second object, wherein determining the acceptance of vending includes offering the one of the objects of the vendor-object pairs for vending conditional on the different vendor vending the second object; and
adds a rule to the vendor response that identifies a condition of the vending of the one of the objects of the vendor-object pairs for vending only with the different vendor vending the second object.

12. The system of claim 9, wherein the processor executes program instructions stored on the computer-readable storage medium via the computer readable memory and thereby:
determines acceptance of vending for one of the objects of the vendor-object pairs conditional on exclusion of another vendor-object pair of a different vendor vending a second object, wherein determining acceptance of vending includes offering the one of the objects of the vendor-object pairs for vending conditional on exclusion the different vendor vending of the second object;
adds a rule to the vendor response that identifies a condition of the vending of the one of the objects of the vendor-object pairs for vending only with excluding the different vendor vending of the second object.

13. The system of claim 12, wherein the processor executes program instructions stored on the computer-readable storage medium via the computer readable memory and thereby:
evaluates inventory for one of the objects of the vendor-object pairs;
adds a rule to offer to vend the one of the objects of the vendor-object pairs according to the evaluated inventory.

14. The system of claim 13, wherein the processor executes program instructions stored on the computer-readable storage medium via the computer readable memory and thereby:
evaluates audience statistics for the deliverer of the digital content as a target audience for vending the one of the objects of the vendor-object pairs.

15. A computer program product for transactional enabled advertisement of requested digital content, the computer program product comprising:
a computer readable storage medium having computer readable program code embodied therewith, wherein the computer readable storage medium is not a transitory signal per se, the computer readable program code comprising instructions for execution by a processor that causes the processor to:
receive a request for digital content, wherein the digital content request comprises a list of vendor-object pairs, wherein each object in the vendor-object pairs is identified in the requested digital content, wherein each object in the vendor-object pairs comprises a request for vending of the object from a corresponding vendor in the vendor-object pairs;
determine an acceptance of the digital content request to offer vending of one or more objects in the vendor-object pairs; and
send a vendor response which offers the vending of the one or more objects in the vendor-object pairs.

16. The computer program product of claim 15, wherein the instructions for execution cause the processor to:
construct the vendor response which comprises a specified advertisement corresponding to one of the objects of the vendor-object pairs according to the determined acceptance, wherein a delivery of the requested digital content includes transactional enablement of the specified advertisement in response to an input which selects the one of the objects of the vendor-object pairs displayed in the requested digital content.

17. The computer program product of claim 15, wherein the instructions for execution cause the processor to:
determine acceptance of vending for one of the objects of the vendor-object pairs conditional on inclusion of another vendor-object pair of a different vendor vending a second object, wherein determining acceptance of vending includes offering the one of the objects of the vendor-object pairs for vending conditional on the different vendor vending the second object; and
add a rule to the vendor response that identifies a condition of the vending of the one of the objects of the vendor-object pairs for vending only with the different vendor vending the second object.

18. The computer program product of claim 15, wherein the instructions for execution cause the processor to:
determine acceptance of vending for one of the objects of the vendor-object pairs conditional on exclusion of another vendor-object pair of a different vendor vending a second object, wherein determining acceptance of vending includes offering the one of the objects of the vendor-object pairs for vending conditional on exclusion the different vendor vending of the second object;
add a rule to the vendor response that identifies a condition of the vending of the one of the objects of the vendor-object pairs for vending only with excluding the different vendor vending of the second object.

19. The computer program product of claim 18, wherein the instructions for execution cause the processor to:
evaluate inventory for one of the objects of the vendor-object pairs;
add a rule to offer to vend the one of the objects of the vendor-object pairs according to the evaluated inventory.

20. The computer program product of claim 18, wherein the instructions for execution cause the processor to:
evaluate audience statistics for the deliverer of the digital content as a target audience for vending the one of the objects of the vendor-object pairs.
